(19) United States
(12) Patent Application Publication
(10) Pub. No.: US 2009/0104324 A1
(43) Pub. Date: Apr. 23, 2009

(54) INFLATABLE INSULATING FOOD SUBSTANCE CONTAINER HOLDER

(75) Inventor: Joseph M. Bradley, Los Angeles, CA (US)

Correspondence Address: LUEDEKA, NEELY & GRAHAM, P.C., P O BOX 1871, KNOXVILLE, TN, 37901, US

(73) Assignee: BRAINSMITH CONCEPTS, LLC, Knoxville, TN (US)

(21) Appl. No.: 12/250,186

(22) Filed: Oct. 13, 2008

Related U.S. Application Data
(60) Provisional application No. 60/980,608, filed on Oct. 17, 2007.

(51) Int. Cl. A47J 39/00; B32B 1/08; B29C 45/14

(52) U.S. Cl. 426/418; 428/35.2; 264/242

(57) ABSTRACT

An inflatable insulating food substance container holder including a plurality of substantially vertically oriented sub-chambers.

### PRIORITY

This application claims priority to provisional patent application Ser. No. 60/980,608 titled INFLATABLE INSULATING BEVERAGE CONTAINER HOLDER filed Oct. 17, 2007, the entire contents of which are incorporated herein by reference.

### FIELD

This disclosure relates to the field of food insulation. More particularly, this disclosure relates to an insulating apparatus for holding a food substance container.

### BACKGROUND

Food substance container insulators of various types have been around for a number of years. One example of a food substance container insulator is the Koozie® can holder offered by Norwood Operating Company, LLC of Indianapolis, Ind. These and other similar insulators perform various functions including insulating the contents of a food substance container by minimizing the heat transfer through the insulator. By minimizing heat transfer, a food substance may be kept cold or warm, depending on the type of food substance and/or the preference of the user. Similarly, the insulating effect shields a user's hand from discomfort (i.e., from an uncomfortably cold or warm food substance container).

One drawback of many food substance container insulators is the inability to store such food substance container insulators in a small space while the food substance container insulators are not in use. U.S. Pat. No. 5,845,806 to Parchman, incorporated herein by reference, proposed to solve this problem by providing an inflatable food substance container insulator having in interior chamber extending through the base of the container insulator. However, by requiring air (or other fluid) to flow through and reside in the base of the container insulator, the container insulator is less stable on hard surfaces. Moreover, if the container insulator were left in water (e.g., a swimming pool), the container insulator could easily flip over. The Parchman reference also gives very little if any insight into ways to subdivide the interior chamber to provide maximum stability, ergonomic effect, minimum stress on the insulator, and maximum insulation.

What is needed, therefore, is an improved inflatable insulating food substance container holder with specific and improved functional features that is easily and inexpensively manufactured.

### SUMMARY

The above and other needs are met by an insulating apparatus for removable engagement with a food substance container. The apparatus includes a first flexible panel including a first edge, a second edge, a third edge, and a fourth edge. The apparatus also includes a second flexible panel including a fifth edge, a sixth edge, a seventh edge, and an eighth edge, wherein the first flexible panel and the second flexible panel are attached along at least a portion of the periphery of the first flexible panel and at least a portion of the periphery of the second flexible panel defining a hermetically sealable chamber between the first flexible panel and the second flexible panel; wherein at least a portion of the first edge is attached to at least a portion of the fifth edge, forming a first weld; wherein at least a portion of the second edge is attached to at least a portion of the sixth edge, forming a second weld; wherein at least a portion of the third edge is attached to at least a portion of the seventh edge, forming a third weld; wherein at least a portion of the fourth edge is attached to at least a portion of the eighth edge, forming a fourth weld; and wherein portions of the first flexible panel are attached to portions of the second flexible panel within the chamber to form at least three partial welds resulting in the formation of at least four interconnected sub-chambers. The apparatus further includes a base panel including a base panel periphery, wherein a first contact surface along the third weld is attached to the base panel along at least a portion of the base panel periphery, and wherein a second contact surface along the second weld is attached to a third contact surface along the fourth weld, thereby forming a cavity for engaging the apparatus with a food substance container.

In one embodiment, the apparatus preferably further includes a valve located along the second flexible panel whereby fluid may be added to the chamber.

In another embodiment, the apparatus includes a base panel further includes a flexible panel. In yet another embodiment, the base panel further comprises an aperture therethrough. In another embodiment, the base panel further includes a weight member attached to the base panel.

In a preferred embodiment, the chamber of the apparatus further includes from about four sub-chambers to about nine sub-chambers. In related embodiment, the sub-chambers are substantially equal in volume when the chamber is substantially fully inflated. In another related embodiment, the chamber includes seven sub-chambers.

In another embodiment, the second contact surface and the third contact surface of the apparatus are attached together form a complete longitudinal weld that separates the two sub-chambers proximate the complete longitudinal weld.

In a preferred embodiment, the apparatus includes a longitudinal length ranging from about 85 mm to about 125 mm; an average inside diameter ranging from about 55 mm to about 75 mm; an average outside diameter ranging from about 65 mm to about 80 mm, and thicknesses of the first flexible panel, the second flexible panel, and the base panel, each ranging from about 5×10⁻³ m to about 3×10⁻⁴ m.

In a preferred embodiment, the apparatus is made of polyvinylchloride.

In a preferred embodiment, the second flexible panel is translucent and the first flexible panel includes an inner surface and an outer surface, wherein at least a portion of the inner surface remains in physical contact with a food substance container when a food substance container is engaged with the apparatus. In a related embodiment, a message is attached to at least a portion of the outer surface of the first flexible panel whereby the message may be viewed through the second flexible panel.

In another aspect, embodiments of the disclosure provide a method for making an insulating apparatus for removable engagement with a food substance container including a first flexible panel, the first flexible panel including a first edge, a second edge, a third edge, and a fourth edge; a second flexible panel including a fifth edge, a sixth edge, a seventh edge, and an eighth edge; a base panel including a base panel periphery. A preferred embodiment of the method includes the steps of (a) welding the first edge to the fifth edge, thereby forming a first weld; (b) welding the second edge to the sixth edge, thereby forming a second weld; (c) welding the third edge to the seventh edge, thereby forming a third weld; (d) welding the fourth edge to the eighth edge, thereby forming a fourth weld; (e) welding the second weld to the fourth weld; and (f) welding the third weld to the base panel periphery. In a related embodiment, the steps (a) through (f) are all accomplished substantially simultaneously. In a related embodiment, the steps (a) through (f) are all accomplished by injection molding. In a related embodiment, the general method described above further includes a step (g) of printing a message on an outer surface of the first flexible panel wherein the second flexible panel is translucent. In a related embodiment, the method described above further includes a step (g)′ of printing a message on an outer surface of the second flexible panel. In a related embodiment, the method described above further includes a step (g)″ of welding a valve to the second flexible panel so that fluid may be added to the chamber.

In another aspect, embodiments of the disclosure provide a method for using an insulating apparatus for removable engagement with a food substance container, wherein the apparatus includes an inflatable structure that forms a cavity for receiving a food substance container, and wherein the inflatable structure includes a plurality of longitudinally oriented inflatable sub-structures. The method includes the steps of (a) inserting a food substance into the cavity of the inflatable structure; and (b) inflating the inflatable structure until the food substance container is held firm in the cavity of the inflatable structure.

Accordingly, it is an object of the disclosure to provide a stable inflatable insulating food substance container holder.

It is another object of the disclosure to provide an inflatable insulating food substance container holder with maximized insulated surface area contacting an engaged food substance container.

It is another object of the disclosure to provide an inflatable insulating food substance container holder with an optimum configuration for limiting localized stress along the inflated portion of the holder.

These and other objects of the present disclosure will become readily apparent upon further review of the following specification and drawings.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a perspective view of an embodiment of an inflatable insulating container holder;

FIG. 2 shows another perspective view of the inflatable insulating container holder shown in FIG. 1.

FIG. 3 shows separate structures that may be attached together to form an inflatable insulating container holder similar to the holder shown in FIG. 1;

FIG. 4 shows another perspective view of the inflatable insulating container holder shown in FIG. 1;

FIG. 5 shows another perspective view of the inflatable insulating container holder shown in FIG. 1;

FIG. 6 shows an end view of another embodiment of an inflatable insulating container holder that includes a weight member; and

FIG. 7 shows a view of a unitary structure that may be interconnected to form a portion of an embodiment of an inflatable insulating container holder.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense).
Brink: The term “brink” is broadly defined as the absolute outer boundary of an object, whether round, polygonal, or other regular of irregular shape.
Edge: The term “edge” is intended to mean a region or sub-region at or near the brink of an object. In the case of an object having a brink with distinct sub-parts (e.g., an object having a polygonal brink), an “edge” would be defined as a sub-region at or near the brink of such object. In the case of an object having a brink with no distinctive sub-parts, the term “edge” is synonymous with the term “periphery” defined below.
Flexible Panel: The term “flexible panel” is intended to mean a flexible substantially flat object made from a material essentially consisting of polymeric material.
Fluid: The term “fluid” is intended to mean any substantially continuous substance in which its parts flow freely past one another. Examples of a fluid include liquids (e.g., water) and gases (e.g., air). Very fine solids that behave as a fluid are also contemplated by this definition.
Food Substance: The term “food substance” is intended to mean food and/or beverage material suitable for human consumption.
Periphery: The term “periphery” is intended to mean a complete boundary region at or near the brink of an object.
Translucent: The term “translucent” is intended to mean a physical and/or chemical property of a material such that visible light may pass through the material. According to this definition, a material that is transparent is necessarily translucent. Thus, an object described as being “translucent” may also be transparent.
Weld (noun): The term “weld” is intended to be broadly defined as a region defined by the attachment of two objects together or the attachment of an object to itself using, for example, heat, adhesive, and/or other means of attaching flexible panels to one another known to a person having ordinary skill in the art.
Weld (verb): The term “weld” is intended to be broadly defined as the action of attaching two objects together or attaching an object to itself using, for example, heat, adhesive, and/or other means of attaching flexible panels to one another known to a person having ordinary skill in the art.

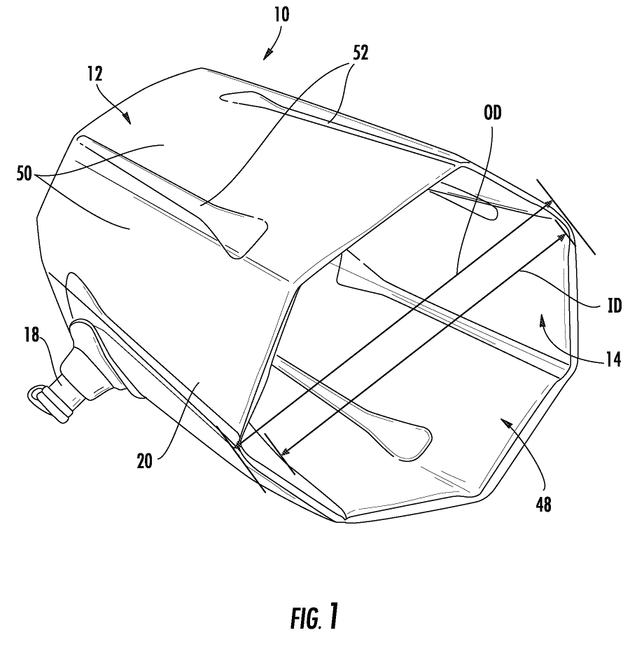

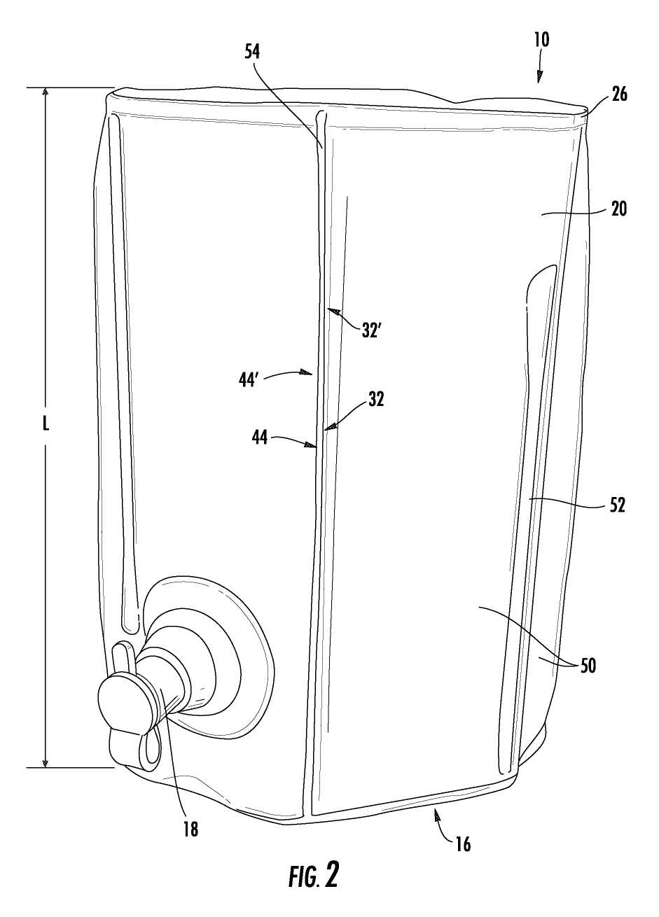

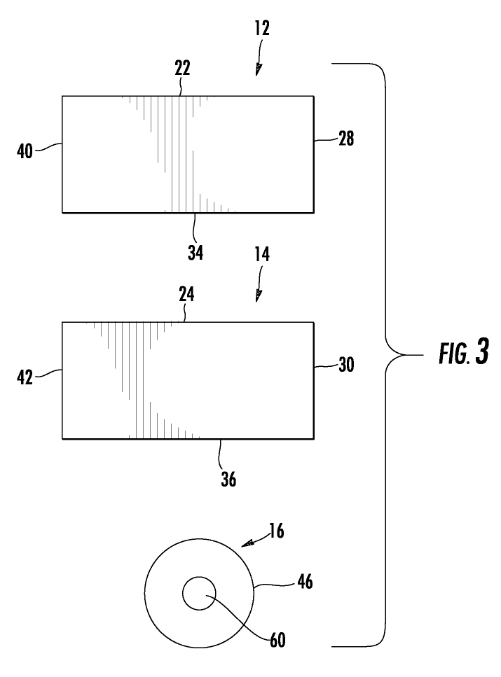

A preferred embodiment of an inflatable insulating food container holder 10 is shown in FIG. 1. With reference to FIGS. 1-3, the holder 10 includes an outer panel 12, an inner panel 14, a base panel 16, and a valve 18. The outer panel 12, the inner panel 14, the base panel 16 are all preferably flexible panels. The outer panel 12 and the inner panel 14 are preferably in the shape of a rectangle and the base panel is preferably in the shape of a circle or polygon having “n” sides wherein preferably 4≦n≦10. In the embodiment shown in FIGS. 1-2, the outer panel 12 and the inner panel 14 are attached together along their respective peripheries, thereby forming a substantially sealed chamber 20. More specifically, for example, a first edge 22 of the outer panel 12 is attached to a fifth edge 24 of the inner panel 14, forming a first weld 26; a second edge 28 of the outer panel 12 is attached to a sixth edge 30 of the inner panel 14, forming a second weld 32; a third edge 34 of the outer panel 12 is attached to a seventh edge 36 of the inner panel 14 forming a third weld 38; and a fourth edge 40 of the outer panel 12 is attached to an eighth edge 42 of the inner panel 14, forming a fourth weld 44. A first contact surface 38′ along the third weld 38 is attached along a base panel periphery 46 of the base panel 16. A second contact surface 32′ located along at least a portion of the second weld 32 is attached to a third contact surface 44′ located along at least a portion of the fourth weld 44, thus defining the holder 10 as including a column-like structure with a cavity 48 for inserting a food container.

The embodiment of the holder 10 shown in FIGS. 1-2 further includes seven longitudinally oriented interconnected sub-chambers 50 separated by six partial longitudinal welds 52 and a primary weld 54. The primary weld 54 shown in FIG. 1 is a complete longitudinal weld that includes the welding of the second contact surface 32′ with the third contact surface 44′. Welds described herein may be formed using melting, gluing, or any other attachment or formation technique known to a person having ordinary skill in the art that provides a substantially hermetic seal. Specifically, for example, the holder 10 may be formed by injection molding techniques. Other techniques may include, for example, compression molding or transfer molding. Although the holder 10 is preferably made by injection molding, the outer panel 12, the inner panel 14, the base panel 16, and the valve 18 may be attached together after the outer panel 12, the inner panel 14, the base panel 16, and the valve 18 are formed using, for example, an adhesive known to a person having ordinary skill in the art for attaching polymeric flexible panels.

Certain embodiments of the holder 10 may be formed with a primary weld 54 that is not in the form of a complete longitudinal weld—a weld that extends along substantially an entire longitudinal surface of a holder. A holder including a primary weld 54 that is not a complete longitudinal weld would include a substantially continuous internal chamber.

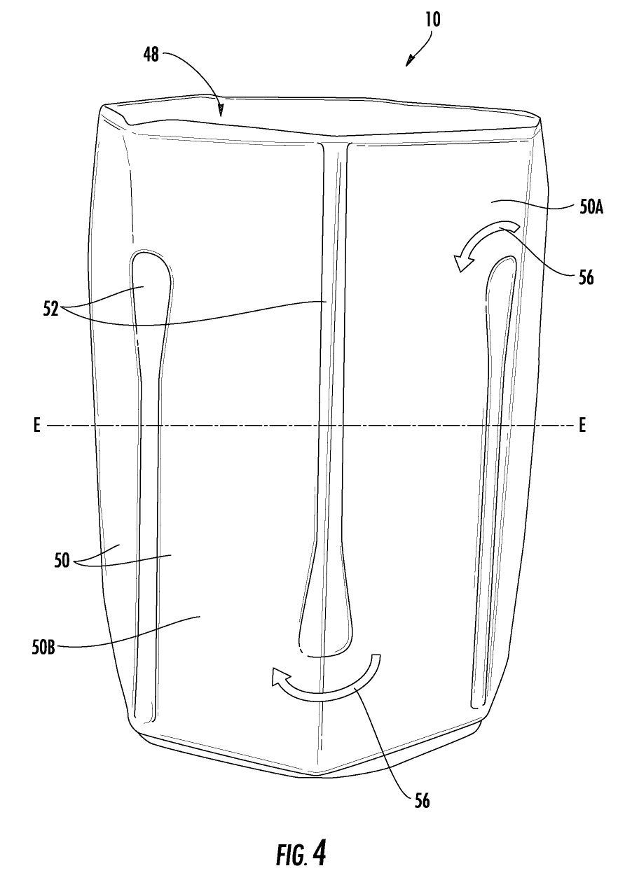

FIG. 4 demonstrates with arrows 56 how fluid may move from one sub-chamber 50A to another sub-chamber 50B. Fluid (e.g., air) may be added and/or removed from the holder 10 via the valve 18. The valve 18 is not necessary in all embodiments, but it is preferred. If applicable, the valve 18 is preferably a retractable valve as commonly used on various swimming pool floatation devices known to a person having ordinary skill in the art. The valve 18 may be positioned anywhere along the outer panel 12, but is preferably located near the base panel 16 of the holder 10, allowing a user to place the valve 18 (in its non-retracted position) between the user's ring finger and little finger for increased grip when holding a hand-held sized embodiment of the invention described herein. If a user prefers to not use the valve 18 for attaining a better grip on the holder 10, the valve 18 may be retracted as desired.

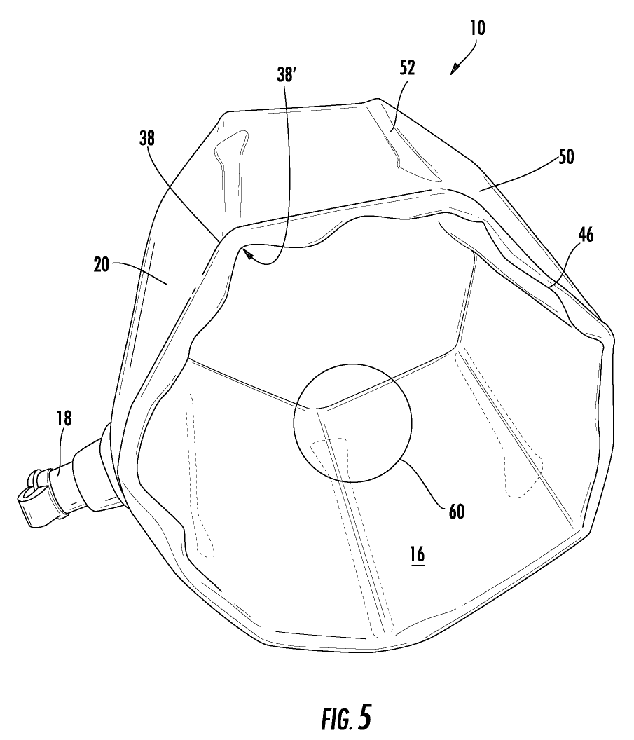

FIG. 5 shows a perspective view from the base panel 16 of the holder 10. The base panel 16 preferably includes an aperture 60 as shown so that air or any fluid may escape when an object (e.g., a food substance container) is inserted into the cavity 48. The aperture 60 also prevents a vacuum from developing when an object is removed from the cavity 48 of the holder 10. The aperture 60 is preferably located substantially in the center of the base panel 16, but one or more apertures may be located in the base panel 16 at various locations in other embodiments.

Although seven sub-chambers 50 are shown in the embodiment of FIGS. 1-2 and FIGS. 4-5, a smaller or larger number of longitudinally oriented sub-chambers may be used in other embodiments preferably ranging from about four longitudinal sub-chambers to about ten longitudinal sub-chambers. More preferably, the number of sub-chambers ranges from six sub-chambers to nine sub-chambers. Most preferably, the number of sub-chambers ranges from seven sub-chambers to eight sub-chambers. The sub-chambers are longitudinally oriented because a substantially longitudinal orientation of welds allows a holder to better conform to a typical curved food substance container, thereby putting less stress on any particular portion of an inflated holder. The pattern of longitudinally oriented sub-chambers shown, for example, in FIG. 1 is also more ergonomic, particularly with regard to hand-held sized embodiments of inflated holders, because the holder expands primarily longitudinally (i.e., not randomly bulging toward an equatorial line “E”), thereby making the holder 10 easier to hold and maintain a grip for various sized hands. Preferably, the sub-chambers are substantially equally sized by volume and shape when a holder is fully inflated.

The preferred number of sub-chambers described above has been derived based in part on the need to maximize the surface area of insulating sub-chambers against, for example, a food substance container surface. Embodiments with more welds necessarily include less fluid insulation contact area along an engaged food substance container. Thus, providing too many sub-chambers (and, therefore, more welds) diminishes the insulating effectiveness of the holder. Moreover, a large number of sub-chambers would make it more difficult to decipher messages (e.g., advertising messages), if any, placed along the outer surface or an inner surface of a holder. However, making a holder that includes too few sub-chambers results in putting more stress on certain peripheries, particularly at or near sharply angled corners and edges of the holder. Such stress increases the likelihood of a leak developing along the holder surface. Thus, preferred embodiments of holders as described herein preferably include a number of insulating sub-chambers that fall within the numerical range described above (i.e., preferably from about 4 to about 10).

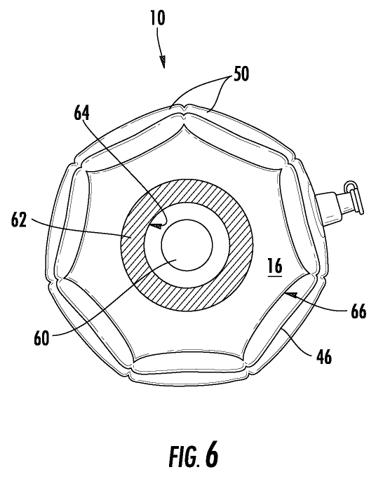

In a preferred embodiment shown in FIG. 6, the base panel 16 includes a weighted member 62 attached to or substantially maintained within the base panel 16. The weighted member 62 is preferably planar. The weighted member 62 shown in FIG. 6 includes a weighted member aperture 64 to allow for the base panel aperture 60 to properly function at a location substantially in the center of the base panel 16. However, the weighted member 62 may come in a variety of shapes including the shape of any standard polygon, circle, or shape with both straight and curved edges, with or without apertures. The weighted member 62 helps stabilize the holder 10, particularly when the holder 10 is floating in water.

A preferred material for making embodiments of holders described herein includes polyvinyl chloride (PVC). Other preferred materials include polypropylene and polyethylene. Although specific examples of preferred materials are given, any suitable thermoplastic or thermosetting plastic material known to a person having ordinary skill in the art may be used to make the holder 10. In a preferred embodiment, the holder 10 is translucent. In a related embodiment, only the outer panel is translucent. In a particular embodiment, a message (e.g., an advertisement and facing outward for display purposes) is placed on an inner surface 66 of the inner panel 14 (i.e., a surface of the inner panel that is adjacent to the chamber) using printing technologies known to a person having ordinary skill in the art; the outer panel 12 is translucent so that the message may be seen. In other embodiments, the holder 10 may also be opaque. Alternatively or additionally, a message may be printed on an outer surface of the outer panel 12 (i.e., on the outside surface of the holder).

The size of a holder may vary depending on the type of container the holder is designed to be engaged with. For example, a hand-held sized holder typically may be made to conform to food substance containers that are to be held by hand. The exact dimensions of a handheld sized holder may vary depending on the size of the can, bottle, or other food substance container such holder is designed for. For a standard soft drink can, for example, a holder preferably includes a length (“L”) ranging from about 85 millimeters (mm) to about 125 mm, and more preferably from about 95 mm to about 115 mm, and most preferably about 105 mm. For a standard soft drink can, the holder preferably includes a partially inflated average inner diameter (“ID”) ranging from about 55 mm to about 75 mm, and more preferably from about 60 mm to about 70 mm, and most preferably about 65 mm. For a standard soft drink can, the holder preferably includes a partially inflated average outer diameter (“OD”) ranging from about 65 mm to about 80 mm, more preferably from about 70 mm to about 75 mm, and most preferably about 72.5 mm. The average thickness of the outer panel 12, the inner panel 14, and the base panel 16 preferably ranges from about 5×10⁻⁵ meters (m) to about 3×10⁻⁴ m, and more preferably from about 1×10⁻⁴ m to about 2×10⁻⁴ m. A wide variety of sizes of holders may be envisioned based on the wide variety of food substance container sizes. For example, a holder may be made to fit a standard 2-liter plastic bottle commonly used to package soft drinks. The correlation between values of length (L), inner diameter, and outer diameter for specific embodiments roughly corresponds to the relative dimensions of the specifically described embodiment given above. Prior to inserting a food substance container into a holder, the inner diameter of the holder is preferably shorter than the diameter of the food substance container that is to be engaged with the holder so that the food substance container will fit relatively tightly within the cavity of the holder once the holder is inflated or otherwise filled with a fluid.

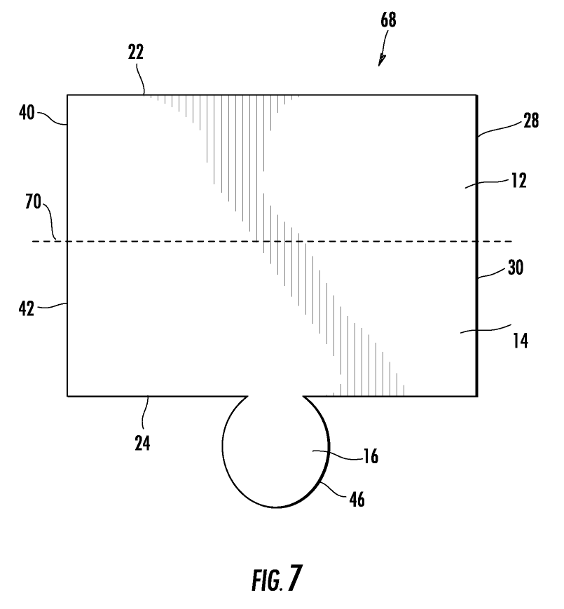

In a preferred embodiment, the outer panel 12, the inner panel 14, and the base panel 16 are initially provided as a unitary structure 68 as shown in FIG. 7, which is further folded along a folding line 70. For the purposes of this embodiment, the folding line 70 represents an imaginary boundary where the outer panel 12 and the inner panel 14 meet. The outer panel 12 and the inner panel 14 are attached along their respective peripheries as described above with reference to holder 10. The complete longitudinal weld 54 is also formed as the sixth edge 30 and the eighth edge 42 of the inner panel 14 are attached to the second edge 28 and the fourth edge 40 of the outer panel 12. The fifth edge 24 of the inner panel 14 and the first edge 22 of the outer panel 12 are attached along the base panel periphery 46 as described above in other embodiments. Partial longitudinal welds may be formed between the inner panel 14 and the outer panel 12 which, in turn, form a plurality of at least four to about ten sub-chambers. The valve 18 may be added at any point during the manufacturing process described in this embodiment, and, alternatively, the valve 18 may be provided as part of the unitary structure 68.

The previously described embodiments of the present disclosure have many advantages, including maximizing insulation effectiveness by increasing the surface area of contact between a holder and a food container, minimizing localized stresses placed on a holder along edges and corners while inflated or otherwise filled with fluid, and maximizing ergonomic effectiveness by limiting excess bulging along a mid-transverse region of a holder. The compartmentalized longitudinal configuration and number of the sub-chambers of holders described herein allows for fluid to be distributed in a manner that causes the holder to obtain a highly ergonomic three dimensional configuration while simultaneously providing optimum insulation.

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An insulating apparatus for removable engagement with a food substance container, the apparatus comprising:
a first flexible panel including a first edge, a second edge, a third edge, and a fourth edge;
a second flexible panel including a fifth edge, a sixth edge, a seventh edge, and an eighth edge, wherein the first flexible panel and the second flexible panel are attached along at least a portion of the periphery of the first flexible panel and at least a portion of the periphery of the second flexible panel defining a hermetically sealable chamber between the first flexible panel and the second flexible panel; wherein at least a portion of the first edge is attached to at least a portion of the fifth edge, forming a first weld; wherein at least a portion of the second edge is attached to at least a portion of the sixth edge, forming a second weld; wherein at least a portion of the third edge is attached to at least a portion of the seventh edge, forming a third weld; wherein at least a portion of the fourth edge is attached to at least a portion of the eighth edge, forming a fourth weld; and wherein portions of the first flexible panel are attached to portions of the second flexible panel within the chamber to form at least three partial welds resulting in the formation of at least four interconnected sub-chambers; and
a base panel including a base panel periphery, wherein a first contact surface along the third weld is attached to the base panel along at least a portion of the base panel periphery, and wherein a second contact surface along the second weld is attached to a third contact surface along the fourth weld, thereby forming a cavity for engaging the apparatus with a food substance container.

2. The insulating apparatus of claim 1, further comprising a valve located along the second flexible panel whereby fluid may be added to the chamber.

3. The apparatus of claim 1 wherein the base panel further comprises a flexible panel.

4. The apparatus of claim 1 wherein the base panel further comprises an aperture therethrough.

5. The apparatus of claim 1 wherein the base panel further comprises a weight member attached to the base panel.

6. The apparatus of claim 1 wherein the chamber comprises from about four sub-chambers to about nine sub-chambers.

7. The apparatus of claim 1 wherein the sub-chambers are substantially equal in volume when the chamber is substantially fully inflated.

8. The apparatus of claim 1 wherein the second contact surface and the third contact surface are attached to form a complete longitudinal weld that separates the two sub-chambers proximate the complete longitudinal weld.

9. The apparatus of claim 1 wherein the longitudinal length of the apparatus ranges from about 85 mm to about 125 mm; wherein the average inside diameter of the of the apparatus ranges from about 55 mm to about 75 mm; wherein the average outside diameter of the apparatus ranges from about 65 mm to about 80 mm, and wherein the thicknesses of the first flexible panel, the second flexible panel, and the base panel range from about 5×10⁻³ m to about 3×10⁻⁴ m.

10. The apparatus of claim 1 wherein the apparatus consists essentially of polyvinylchloride.

11. The apparatus of claim 1 wherein the second flexible panel is translucent and wherein the first flexible panel includes an inner surface and an outer surface, wherein at least a portion of the inner surface remains in physical contact with a food substance container when a food substance container is engaged with the apparatus.

12. The apparatus of claim 6 wherein the chamber comprises seven sub-chambers.

13. The apparatus of claim 11 wherein a message is attached to at least a portion of the outer surface of the first flexible panel whereby the message may be viewed through the second flexible panel.

14. A method for making an insulating apparatus for removable engagement with a food substance container including a first flexible panel, the first flexible panel including a first edge, a second edge, a third edge, and a fourth edge; a second flexible panel including a fifth edge, a sixth edge, a seventh edge, and an eighth edge; a base panel including a base panel periphery, the method comprising the steps of:
a. welding the first edge to the fifth edge, thereby forming a first weld;
b. welding the second edge to the sixth edge, thereby forming a second weld;
c. welding the third edge to the seventh edge, thereby forming a third weld;
d. welding the fourth edge to the eighth edge, thereby forming a fourth weld;
e. welding the second weld to the fourth weld; and
f. welding the third weld to the base panel periphery.

15. The method of claim 14 wherein the steps (a) through (f) are all accomplished substantially simultaneously.

16. The method of claim 14 further comprising a step (g) of printing a message on an outer surface of the first flexible panel wherein the second flexible panel is translucent.

17. The method of claim 14 further comprising a step (g)′ of printing a message on an outer surface of the second flexible panel.

18. The method of claim 15 wherein steps (a) through (f) are accomplished by injection molding.

19. The method of claim 14 further comprising a step (g)″ of welding a valve to the second flexible panel so that fluid may be added to the chamber.

20. A method for using an insulating apparatus for removable engagement with a food substance container, wherein the apparatus includes an inflatable structure that forms a cavity for receiving a food substance container, and wherein the inflatable structure includes a plurality of longitudinally oriented inflatable sub-structures, the method comprising the steps of:
a. inserting a food substance into the cavity of the inflatable structure; and
b. inflating the inflatable structure until the food substance container is held firm in the cavity of the inflatable structure.
